(19) United States
(12) Patent Application Publication
(10) Pub. No.: US 2026/0160927 A1
(43) Pub. Date: Jun. 11, 2026

(54) ADHESIVE FILM, OPTICAL MEMBER, AND OPTICAL DISPLAY APPARATUS

(71) Applicant: SAMSUNG SDI CO., LTD., Yongin-si (KR)

(72) Inventors: Sung Hyun MUN, Suwon-si (KR); Do Young KIM, Suwon-si (KR); Jin Young LEE, Suwon-si (KR); Kyoung Gon PARK, Suwon-si (KR); Dong Myeong SHIN, Suwon-si (KR); Sung Han KIM, Suwon-si (KR); Ji Won KANG, Suwon-si (KR); Geon Yong MAENG, Suwon-si (KR); Il Jin KIM, Suwon-si (KR)

(73) Assignee: SAMSUNG SDI CO., LTD., Yongin-si (KR)

(21) Appl. No.: 19/179,135

(22) Filed: Apr. 15, 2025

(30) Foreign Application Priority Data
Apr. 19, 2024 (KR) 10-2024-0052667

(51) Int. Cl. G02B 1/16; G02B 1/111; G02B 1/12; G02B 1/14

(52) U.S. Cl. CPC G02B 1/16; G02B 1/111; G02B 1/12; G02B 1/14

(57) ABSTRACT

An adhesive film for a polyimide-based optical device containing a polyimide ash, an optical member, and an optical display apparatus are provided. The adhesive film includes a cured product of a composition comprising 100 parts by weight of a (meth)acrylic binder having a glass transition temperature in a range of about −70° C. to about −40° C., about 0.1 to about 5 parts by weight of a (meth)acrylic oligomer, about 0.01 to about 0.5 parts by weight of a curing agent, and an antistatic agent.

### CROSS-REFERENCE TO RELATED APPLICATION

This application claims priority to Korean Patent Application No. 10-2024-0052667, filed on Apr. 19, 2024 in the Korean Intellectual Property Office, the entire disclosure of which is incorporated herein by reference.

### FIELD OF THE DISCLOSURE

The present disclosure relates to an adhesive film, an optical member, and an optical display apparatus.

### DESCRIPTION OF THE RELATED ART

Technical interest in foldable optical displays is increasing. The development of adhesive films for foldable displays has also progressed. The adhesive film is required to have desired optical transparency, peel strength to an adherend, and foldability. The adhesive film is typically included to attach various components, such as windows, protective films, polarizers, touch panels, and the like, in a foldable optical display.

The adhesive film may also be adhered to one surface of an optical display panel of a foldable optical display. The adhesive film may bond the optical display panel to another adhesive film or protective film. The optical display panel may include a polyimide layer. The polyimide layer is often included in optical display panels due to the desired heat resistance thereof. The polyimide layer may be prepared by depositing a polyimide composition on a substrate and curing the composition, followed by peeling a coating layer off of the substrate. Thus, it is desirable for the adhesive film to have high peel strength and desired flexural property, which is the ability of a material to resist bending and deformation, with respect to the polyimide layer.

The background technique of the present disclosure is disclosed in Korean Patent Laid-open Publication No. 10-2017-0070753, and the like.

### SUMMARY OF THE DISCLOSURE

It is one example object of the present disclosure to provide an adhesive film that has high peel strength with respect to a polyimide ash-containing surface of a polyimide-based optical device.

It is another example object of the present disclosure to provide an adhesive film that has desired step-filling properties for steps caused by polyimide ash when adhered to a polyimide ash-containing surface of a polyimide-based optical device.

It is a further example object of the present disclosure to provide an adhesive film that has desired flexural properties and antistatic performance.

In accordance with one example aspect of the present disclosure, an adhesive film for a polyimide-based optical device containing a polyimide ash includes a cured product of a composition including about 100 parts by weight of a (meth)acrylic binder having a glass transition temperature (Tg) in a range of about −70° C. to about −40° C., about 0.1 parts by weight to about 5 parts by weight of a (meth)acrylic oligomer, about 0.01 parts by weight to about 0.5 parts by weight of a curing agent, and an antistatic agent.

In accordance with another example aspect of the present disclosure, an optical member includes a polyimide-based optical device containing a polyimide ash in at least one surface thereof, and an adhesive film adhered to the one surface containing the polyimide ash therein.

In accordance with a further example aspect of the present disclosure, an optical display apparatus includes the adhesive film or the optical member.

Example embodiments of the present disclosure include an adhesive film that has high peel strength with respect to a polyimide ash-containing surface of a polyimide-based optical device.

Example embodiments of the present disclosure include an adhesive film that has a desired step-filling property for steps caused by polyimide ash when adhered to a polyimide ash-containing surface of a polyimide-based optical device.

Example embodiments of the present disclosure include an adhesive film that has desired flexural properties and antistatic performance.

### BRIEF DESCRIPTION OF THE DRAWINGS

FIG. 1 is sectional views of example embodiments of a method of forming a polyimide layer including a polyimide ash-containing surface.

FIG. 2 is a cross-sectional view of a specimen for evaluation of flexural properties.

FIG. 3 is a cross-sectional view of a specimen for evaluation of step-filling properties.

### DETAILED DESCRIPTION

Hereinafter, example embodiments of the present disclosure are described in detail with reference to the accompanying drawings such that the present disclosure can be readily implemented by a person having ordinary knowledge in the art. It should be understood that the present disclosure may be embodied in different ways and is not limited to the following embodiments.

The terminology used herein is for the purpose of describing example embodiments and is not intended to limit the present disclosure. As used herein, the singular forms “a”, “an”, and “the” are intended to include the plural forms as well, unless the context for example indicates otherwise.

Herein, “(meth)acryl” refers to acryl and/or methacryl.

Herein, “copolymer” may include a polymer or a resin.

Herein, “homopolymer glass transition temperature” may refer to a glass transition temperature (Tg) measured on a homopolymer of a target monomer using a DSC Discovery (TA Instruments). For example, the homopolymer of the target monomer is heated to a temperature of about 180° C. at a heating rate of about 20° C./min, is slowly cooled to about −100° C., and is heated again to about 100° C. at a heating rate of about 10° C./min to obtain data of an endothermic transition curve. An inflection point of the endothermic transition curve may be defined as the glass transition temperature of the target monomer in a homopolymer phase.

Herein, the glass transition temperatures of “(meth)acrylic binder” and “(meth)acrylic oligomer” may be measured by any methods known to those skilled in the art through differential scanning calorimetry (DSC).

As used herein to represent a specific numerical range, “X to Y” means a value greater than or equal to X and less than or equal to Y (X≤ and ≤Y).

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

According to one example embodiment, the adhesive film may be adhered to a polyimide ash-containing surface of a polyimide-based optical device. The adhesive film may be adhered to the polyimide ash-containing surface to protect the polyimide-based optical device, or to attach the polyimide-based optical device to another optical device.

One example embodiment of the present disclosure includes an adhesive film that has high peel strength with respect to a polyimide ash-containing surface of a polyimide-based optical device. One example embodiment of the present disclosure includes an adhesive film that has desired step-filling properties for steps caused by polyimide ash when adhered to a polyimide ash-containing surface of a polyimide-based optical device. One example embodiment of the present disclosure includes an adhesive film that has desired flexural properties and antistatic performance.

For example, the adhesive film may have a peel strength in a range of about 300 gf/inch or more, for example, in a range of about 300, 310, 320, 330, 330, 340, 350, 360, 370, 380, 390, 400, 410, 420, 430, 440, 450, 460, 470, 480, 490, 500, 510, 520, 530, 540, 550, 560, 570, 580, 590, 600 gf/inch, in a range of about 300 gf/inch to about 600 gf/inch, with respect to the polyimide ash-containing surface. Within this range, the adhesive film can have desired flexural properties even when adhered to the polyimide ash-containing surface, and can be reliably adhered to the polyimide-based optical device.

For example, the adhesive film may have desired step-filling properties by reducing or preventing generation of foreign matter and/or bubbles, delamination of the adhesive film, and misalignment of the adhesive film when adhered to the polyimide ash-containing surface.

For example, the adhesive film may have desired flexural properties by reducing or preventing generation of bubbles, lifting and/or delamination in evaluation of flexural properties as described in experimental examples described below.

For example, the adhesive film may have a surface resistance in a range of about 9.9×10¹² (Ω/cm²) or less, for example, 1.0×10⁶, 1.0×10⁷, 1.0×10⁸, 1.0×10⁹, 1.0×10¹⁰, 1.0×10¹¹, 1.0×10¹² Ω/cm², for example 1.0×10⁶ Ω/cm² to 1.0×10¹² Ω/cm². Within this range, the adhesive film can exhibit desired antistatic performance by reducing or suppressing generation of static electricity when peeled off of a release film in a process of manufacturing the adhesive film.

The “polyimide-based optical device” may refer to an optical device including a polyimide layer on an outermost surface thereof. The polyimide layer may be formed of or include a composition including at least one of a polyimide polymer, a polyimide copolymer, a polyimide oligomer, and a polyimide monomer. The polyimide layer of the polyimide-based optical device may be composed of or include a single layer or multiple layers. A remaining portion of the polyimide-based optical device excluding the polyimide layer may be composed of or include a single layer or multiple layers. According to one example embodiment, the “polyimide-based optical device” may be or include a panel for optical displays, a protective film for optical displays, or the like, and may be or include, for example, an optical device included in a foldable optical display apparatus.

The “polyimide” may refer to a copolymer, polymer, or oligomer prepared by polymerization of a polyamic acid as a precursor and containing an imide group and an aromatic group within a repeat unit.

According to one example embodiment, “polyimide ash” may be prepared by performing laser treatment on the polyimide layer. For example, laser treatment may be performed under room temperature/normal pressure conditions.

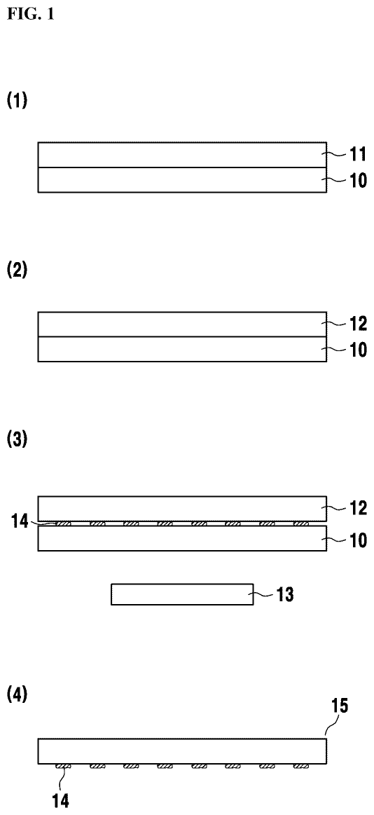

According to one example embodiment, the polyimide ash-containing surface may be formed by the following process, as described with reference to FIG. 1.
(1) A polyimide varnish is deposited to a thickness in a range of about 20 m to about 30 m on an upper surface of a glass plate 10 (for example, an alkali-free glass plate, thickness: range of about 1 mm to about 2 mm) to form a polyimide varnish coating 11. The polyimide varnish may include about 90 wt % or more of at least one of a polyimide copolymer, a polyimide oligomer, and a polyimide monomer, without being limited thereto. Such a process can provide a thickness reduction effect to a final polyimide layer.
(2) The prepared polyimide varnish coating film 11 is dried at a temperature of about 150° C. for a duration of about 30 min, and cured at about 250° C. for about 30 min to form a cured polyimide film 12 on the upper surface of the glass plate 10.
(3) When the lower surface of the glass plate 10 is irradiated with laser beams 13 under the laser treatment conditions, a polyimide ash 14 is formed on a lower surface of the cured polyimide film 12. The laser treatment may form the polyimide ash 14 by burning a portion of the cured polyimide film 12. The polyimide ash 14 may refer to fine irregularities in the form of dust, which may form a fine step between a laser-treated portion and a non-laser-treated portion. The step can facilitate delamination of the glass plate in step (4) further discussed below. The extent to which the polyimide ash 14 is formed, or the ratio of an area in which the polyimide ash 14 is formed (ratio of the total area of the polyimide ash 14 to the total area of the cured polyimide film 12 or the polyimide layer), may be adjusted depending on the type of polyimide varnish, the total thickness of the polyimide layer, and the like.
(4) The glass plate 10 may be peeled off of the cured polyimide film 12, thereby providing a polyimide layer 15 that includes a surface containing the polyimide ash 14.

The “polyimide layer” may be or include a portion of the polyimide-based optical device.

According to one example embodiment, the adhesive film includes a cured product of a composition including 100 parts by weight of a (meth)acrylic binder having a glass transition temperature in a range of about −70° C. to about −40° C., about 0.1 parts by weight to about 5 parts by weight of a (meth)acrylic oligomer, about 0.01 parts by weight to about 0.5 parts by weight of a curing agent, and an antistatic agent.

According to one example embodiment, the composition may be or include a thermosetting composition, and the cured product may be or include a thermally cured product of the composition.

According to one example embodiment, the adhesive film may be or include a pressure sensitive adhesive (PSA) film.

The (meth)acrylic binder may be cured by a curing agent to form a matrix of the adhesive film while increasing peel strength of the adhesive film.

The (meth)acrylic binder has a glass transition temperature in a range of about −70° C. to about −40° C. A (meth)acrylic binder having a glass transition temperature that is less than about −70° C. can make it difficult to achieve peel strength of the adhesive film according to the present disclosure. A (meth)acrylic binder having a glass transition temperature that is greater than about −40° C. can provide poor flexural and step-filling properties to the adhesive film. For example, the (meth)acrylic binder may have a glass transition temperature, for example about −70, −69, −68, −67, −66, −65, −64, −63, −62, −61, −60, −59, −58, −57, −56, −55, −54, −53, −52, −51, −50, −49, −48, −47, −46, −45, −44, −43, −42, −41, −40° C., in a range of about −65° C. to about −40° C.

The (meth)acrylic binder may be or include a (meth)acrylic copolymer prepared through polymerization of a monomer mixture. For the monomer mixture, it should be noted that the present disclosure is limited neither to a particular type of monomer nor to a particular content of each monomer, as long as the above glass transition temperature can be achieved.

According to one example embodiment, the monomer mixture may include a (meth)acrylic monomer having a homopolymer glass transition temperature in a range of about −50° C. or less, for example about −80, −75, −70, −65, −60, −55, −50° C., about −80° C. to about −50° C. Within this range, the (meth)acrylic binder can readily reach the glass transition temperature within the above range.

The (meth)acrylic monomer having a homopolymer glass transition temperature of about −50° C. or less, for example in a range of about −80° C. to about −50° C., is not limited to a particular type of (meth)acrylic monomer as long as the (meth)acrylic monomer has the glass transition temperature within the above range. The glass transition temperature may be determined with reference to catalogs of the corresponding (meth)acrylic monomer, or by a typical method known to those skilled in the art.

In one example embodiment, the (meth)acrylic monomer having a homopolymer glass transition temperature in a range of about −50° C. or less may include at least one straight or branched C₁ to C₁₀ alkyl group-containing (meth)acrylic acid ester. For example, the straight or branched C₁ to C₁₀ alkyl group-containing (meth)acrylic acid ester may include at least one of n-butyl acrylate, 2-ethylhexyl acrylate, isodecyl acrylate, and isononyl acrylate, without being limited thereto.

In one example embodiment, the (meth)acrylic monomer having a homopolymer glass transition temperature of about −50° C. or less may be present in an amount in a range of about 90 wt % or more, for example about 90, 91, 92, 93, 94, 95, 96, 97, 98, 99, 100 wt %, in a range of about 90 wt % to about 100 wt %, in the monomer mixture. Within this range, the (meth)acrylic binder can readily reach the glass transition temperature within the above range.

In one example embodiment, the monomer mixture may include about 40 wt % to less than 100 wt %, for example, about 40, 45, 50, 55, 60, 65, 70, 75, 80, 85, 90, 95, 99 wt %, about 40 wt % to about 90 wt %, of a (meth)acrylic monomer having a homopolymer glass transition temperature of about −50° C. or less and containing a branched C₃ to C₁₀ alkyl group, and optionally about 60 wt % or less, for example, about 1, 5, 10, 15, 20, 25, 30, 35, 40, 45, 50, 55, 60 wt %, in a range of about 10 wt % to about 60 wt %, of a (meth)acrylic monomer having a homopolymer glass transition temperature of about −50° C. or less and containing a linear C₁ to C₁₀ alkyl group. Within this range, the (meth)acrylic binder can readily reach the glass transition temperature within the above range.

The monomer mixture may further include a (meth)acrylic monomer having a homopolymer glass transition temperature that is greater than about −50° C. However, the content of the monomer having a homopolymer glass transition temperature that is greater than about −50° C. in the monomer mixture should not affect the glass transition temperature range of the (meth)acrylic binder. For example, the (meth)acrylic monomer having a homopolymer glass transition temperature that is greater than about −50° C. may be present in an amount that is less than about 10 wt %, for example, about 0, 0.01, 0.1, 1, 2, 3, 4, 5, 6, 7, 8, 9, 9.9 wt %, in a range of about 0.01 wt % to less than 10 wt %, in the monomer mixture.

For example, the (meth)acrylic monomer having a homopolymer glass transition temperature that is greater than about −50° C. may have a homopolymer glass transition temperature that is greater than about −50° C. and less than or equal to about 150° C. The (meth)acrylic monomer having a homopolymer glass transition temperature that is greater than about −50° C. may include at least one of a (meth)acrylic monomer having an aromatic group, a (meth)acrylic monomer having an alicyclic group, a (meth)acrylic monomer having a heterocyclic group, and a (meth)acrylic monomer having an amino group.

The monomer mixture may further include a (meth)acrylic monomer having a crosslinkable functional group to increase peel strength of the adhesive film. The (meth)acrylic monomer having a crosslinkable functional group may be or include a hydroxyl group-containing (meth)acrylic monomer.

The hydroxyl group-containing (meth)acrylic monomer may be or include a (meth)acrylic acid ester containing a straight or branched C₁ to C₁₀ alkyl group having at least one hydroxyl group. For example, the (meth)acrylic acid ester may include hydroxypropyl (meth)acrylates including 2-hydroxypropyl (meth)acrylate and 3-hydroxypropyl (meth)acrylate, hydroxybutyl (meth)acrylate including 4-hydroxybutyl (meth)acrylate, and the like, without being limited thereto.

The hydroxyl group-containing (meth)acrylic monomer may be present in an amount that is less than about 10 wt % in the monomer mixture, for example, about 0, 0.01, 0.1, 1, 2, 3, 4, 5, 6, 7, 8, 9, 9.9 wt %, in a range of about 0.01 wt % to less than 10 wt %. Within this range, the composition can efficiently realize the effects of the adhesive film according to the present disclosure.

The (meth)acrylic binder may have a weight average molecular weight (Mw) of about 1,500,000 g/mol or less, for example in a range of about 900,000 g/mol to about 1,500,000 g/mol. Within this range, the (meth)acrylic binder can readily form a matrix of the adhesive film while improving peel strength and reliability thereof. The “weight average molecular weight” may be measured by, e.g., gel permeation chromatography based on a polystyrene standard.

The (meth)acrylic binder may have a polydispersity index (PDI) of about 10 or less, for example about 3, 4, 5, 6, 7, 8, 9, 10, in a range of about 3 to about 10. Within this range, the (meth)acrylic binder can readily form a matrix of the adhesive film while improving peel strength and reliability thereof.

The (meth)acrylic binder may be prepared by polymerizing the monomer mixture by a typical polymerization method. The polymerization method may include any typical method known to those skilled in the art. For example, the (meth)acrylic binder may be prepared by adding an initiator to the monomer mixture, followed by typical copolymer polymerization, for example, suspension polymerization, emulsion polymerization, solution polymerization, and the like. Polymerization may be performed at a temperature in a range of about 60° C. to about 70° C. for a duration in the range of about 6 hours to about 8 hours. The initiator may be or include a typical initiator including an azo-based polymerization initiator; and/or a peroxide, such as, e.g., benzoyl peroxide or acetyl peroxide.

The (meth)acrylic oligomer is configured to increase peel strength of the adhesive film. Although the adhesive film can be formed of or include a thermosetting composition and may have a thin thickness, the adhesive film can present a challenge of low peel strength. The (meth)acrylic oligomer can increase peel strength of the adhesive film through increase in cohesion of the adhesive film.

The (meth)acrylic oligomer is present in an amount in a range of about 0.1 parts by weight to about 5 parts by weight relative to 100 parts by weight of the (meth)acrylic binder. When the amount of the (meth)acrylic oligomer is less than about 0.1 parts by weight, the adhesive film may not achieve peel strength according to the present disclosure. When the amount of the (meth)acrylic oligomer exceeds about 5 parts by weight, the adhesive film can exhibit poor flexural and step-filling properties. For example, the (meth)acrylic oligomer may be present in an amount in a range of about 0.1, 0.2, 0.3, 0.4, 0.5, 0.6, 0.7, 0.8, 0.9, 1, 1.5, 2, 2.5, 3, 3.5, 4, 4.5, 5 parts by weight, about 0.1 parts by weight to about 3 parts by weight, about 0.5 parts by weight to about 2 parts by weight, or about 0.5 parts by weight to about 1.5 parts by weight, relative to 100 parts by weight of the (meth)acrylic binder.

According to one example embodiment, the (meth)acrylic oligomer has a higher glass transition temperature than the (meth)acrylic binder, and may have a glass transition temperature in a range of, for example, about 10° C. to about 40° C., about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40° C., or about 20° C. to about 40° C. Within this range, the (meth)acrylic oligomer can assist in increase in peel strength of the adhesive film while achieving desired flexural and step-filling properties.

According to one example embodiment, the (meth)acrylic oligomer may have a lower weight average molecular weight than the (meth)acrylic binder, and may have a weight average molecular weight in a range of, for example, about 3,000 g/mol to about 50,000 g/mol, for example 3,000 g/mol, 4,000 g/mol, 5,000 g/mol, 6,000 g/mol, 7,000 g/mol, 8,000 g/mol, 9,000 g/mol, 10,000 g/mol, 15,000 g/mol, 20,000 g/mol, 25,000 g/mol, 30,000 g/mol, 35,000 g/mol, 40,000 g/mol, 45,000 g/mol, 50,000 g/mol, or about 5,000 g/mol to about 50,000 g/mol. Within this range, the (meth)acrylic oligomer can increase cohesion of the adhesive film.

The (meth)acrylic oligomer may include an oligomer of a monomer mixture including a hydroxyl group-containing (meth)acrylic monomer. The hydroxyl group may be included in the (meth)acrylic oligomer to provide an effect of improving high temperature/humidity durability. The hydroxyl group-containing (meth)acrylic monomer in the (meth)acrylic oligomer can assist in increasing the peel strength of the adhesive film while securing foldability at low temperature, when the (meth)acrylic binder is or includes a (meth)acrylic binder that is free from a crosslinkable functional group, such as, e.g., a hydroxyl group or a carboxylic acid group. The hydroxyl group-containing (meth)acrylic monomer may include, e.g., 4-hydroxybutyl (meth)acrylate, hydroxyethyl (meth)acrylate, and the like, without being limited thereto. The hydroxyl group-containing (meth)acrylic monomer may be present in an amount in a range of about 0.1 wt % to about 99.9 wt % in the monomer mixture.

The (meth)acrylic oligomer may include a (meth)acrylic monomer having a homopolymer glass transition temperature in a range of about 90° C. or more, for example, about 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120° C., about 100° C. to about 120° C., as a major component. Within this range, it is possible to reduce or prevent excessive increase in storage modulus of the adhesive film at high temperature while securing the above range of glass transition temperature. For example, the (meth)acrylic monomer may include a monofunctional (meth)acrylic monomer, for example, methyl acrylate, hydroxyethyl methacrylate, and the like, without being limited thereto. Here, “major component” means that the corresponding monomer is present in an amount in a range of about 50 wt % or more, about 60 wt % or more, or about 100 wt % or less, in the (meth)acrylic oligomer.

The (meth)acrylic oligomer may further include a (meth)acrylic monomer having a homopolymer glass transition temperature in a range of about 50° C. or less, for example, about −80° C. to about 0° C.

In one example embodiment, the (meth)acrylic oligomer may include an oligomer of a monomer mixture including 4-hydroxybutyl (meth)acrylate and methyl methacrylate. The monomer mixture may further include methacrylic acid and/or N-butyl (meth)acrylate.

The curing agent can form a matrix of the adhesive film, and can improve reliability of the adhesive film by thermally curing the (meth)acrylic binder.

In one example embodiment, the curing agent may be or include an isocyanate curing agent.

The isocyanate curing agent may include a bi- or higher functional isocyanate curing agent, for example a bi- to hexa-functional isocyanate curing agent. In one example embodiment, the isocyanate curing agent may include at least one aromatic isocyanate curing agent, or aliphatic isocyanate curing agent, such as or including at least one of xylene diisocyanate (XDI) including m-xylene diisocyanate and the like, methylenebis(phenyl isocyanate) (MDI) including 4,4′-methylenebis(phenyl isocyanate) and the like, naphthalene diisocyanate, toluene diisocyanate, hexamethylene diisocyanate, and isophorone diisocyanate, or adducts thereof. For example, the adducts may include at least one of trimethylol propane adducts of toluene diisocyanate, trimethylol propane adducts of hexamethylene diisocyanate, trimethylol propane adducts of isophorone diisocyanate, trimethylol propane adducts of xylene diisocyanate, isocyanurates of toluene diisocyanate, isocyanurates of hexamethylene diisocyanate, and isocyanurates of isophorone diisocyanate. The isocyanate curing agent may include at least one of these compounds.

The isocyanate curing agent may be present in an amount in a range of about 0.01 parts by weight to about 0.5 parts by weight relative to 100 parts by weight of the (meth)acrylic binder. When the amount of the isocyanate curing agent is less than about 0.01 parts by weight, the adhesive film may not achieve peel strength according to the present disclosure. When the amount of the isocyanate curing agent exceeds about 0.5 parts by weight, the adhesive film can exhibit poor flexural and step-filling properties. For example, the isocyanate curing agent may be present in an amount in a range of about 0.05 parts by weight to about 0.3 parts by weight relative to 100 parts by weight of the (meth)acrylic binder.

The composition may further include a curing agent that is free from an isocyanate group (hereinafter also referred to as a “non-isocyanate curing agent”).

The non-isocyanate curing agent may include at least one of a metal chelate curing agent, a carbodiimide curing agent, an aziridine curing agent, and an epoxy curing agent. For example, the non-isocyanate curing agent includes a metal chelate curing agent. The metal chelate curing agent can increase the curing rate of the (meth)acrylic binder.

The metal chelate curing agent may include a typical metal chelate curing agent. For example, the metal chelate curing agent may be or include a curing agent containing a metal, such as at least one of aluminum, titanium, iron, copper, zinc, tin, titanium, nickel, antimony, magnesium, vanadium, chromium, and zirconium. For example, the metal chelate curing agent may include at least one of aluminum ethyl acetoacetate diisopropylate, aluminum tris(ethyl acetoacetate), alkyl acetoacetate aluminum diisopropylate, aluminum isopropylate, mono-sec-butoxyaluminum diisopropylate, aluminum-sec-butyrate, aluminum ethylate, tetra-isopropyl titanate, tetra-n-butyl titanate, butyl titanate dimer, titanium acetyl acetonate, titanium octylene glycolate, titanium tetra-acetyl acetonate, titanium ethyl acetate, polyhydroxytitanium stearate, and aluminum acetyl acetonate.

The non-isocyanate curing agent may be present in an amount in a range of about 5 parts by weight or less, for example about 0.5 parts by weight or less, about 0.01 parts by weight to about 2 parts by weight, about 0.01 parts by weight to about 0.2 parts by weight relative to 100 parts by weight of the (meth)acrylic binder. Within this range, the non-isocyanate curing agent can provide additional effects without impairing the effects of the adhesive film according to the present disclosure.

The antistatic agent may include at least one of an ionic liquid, an ionic electrical conductor, such as a bis(fluorosulfonyl)imide salt, or a surfactant.

The ionic liquid may include a material containing a cationic component, such as at least one of phosphonium ions, pyridinium ions, pyrrolidinium ions, imidazolium ions, guanidium ions, ammonium ions, isouronium ions, thiouronium ions, piperidinium ions, pyrazolium ions, sulfonium ions, quaternary ammonium, quaternary phosphonium, and the like, and an anion component, such as halogen ions, nitric acid ions, sulfuric acid ions, phosphoric acid ions, perchloric acid ions, thiocyanic ions, thiosulfuric acid ions, sulfurous acid ions, tetrafluoroborate ions, hexafluorophosphate ions, formic acid ions, oxalic acid ions, acetic acid ions, trifluoroacetic acid ions, alkylsulfonic acid ions, and the like.

Example ionic liquids may include at least one of 1-allyl-3-methylimidazolium chloride, 1,3-dimethylimidazolium chloride, 1,3-dimethylimidazolium dimethyl phosphate, 1-ethyl-3-methylimidazolium chloride, 1-ethyl-3-methylimidazolium bromide, 1-ethyl-3-methylimidazolium iodide, 1-ethyl-3-methanesulfonate, 1-ethyl-3-methylimidazolium tetrafluoroborate, 1-ethyl-3-methylimidazolium hexafluorophosphate, 1-ethyl-3-methylimidazolium p-toluenesulfonate, 1-butyl-3-methylimidazolium chloride, 1-hexyl-3-methylimidazolium chloride, 1-methyl-1-propyl-pyrrolidinium bis(trifluoromethanesulfonyl)imide, 1-methyl-1-methylpyrrolidinium bromide, 1-butyl-1-methylpiperidinium bromide, 1-ethylpyridinium chloride, 1-ethylpyridinium bromide, 1-butylpyridinium chloride, 1-butylpyridinium bromide, 1-butyl-3-methylpyridinium chloride, 1-ethyl-3-methylpyridinium ethyl sulfate, 1-butyl-4-methylpyridinium chloride, 1-butyl-4-methylpyridinium hexafluorophosphate, trimethylpropylammonium bis(trifluoromethanesulfonyl)imide, tributylmethylammonium bis(trifluoromethanesulfonyl)imide (alternatively: tri-n-butylmethylammonium bistrifluoromethanesulfonimide), tetrabutylammonium chloride, tetrabutylammonium bromide, cyclohexyltrimethylammonium bis(trifluoromethanesulfonyl)imide, tetrabutylphosphonium bromide and the like.

The surfactant may include non-ionic surfactants or ionic surfactants.

The non-ionic surfactants may include, for example, polyethylene glycol alkyl ether, polyoxyalkylene alkyl ether, and the like.

The ionic surfactants may include cationic surfactants, such as alkyltrimethylammonium halides having a carbon number in a range of about 8 to about 22, and anionic surfactants, such as alkyl sulfates.

The antistatic agent may be present in an amount in a range of about 0.001 parts by weight to about 0.1 parts by weight, for example about 0.005 parts by weight to about 0.1 parts by weight, relative to 100 parts by weight of the (meth)acrylic binder. Within this range, the adhesive film can be readily removed from a release film in the process of manufacturing the adhesive film.

According to one example embodiment, the (meth)acrylic binder, the (meth)acrylic oligomer, the curing agent, and the antistatic agent may be present in a total amount in a range of about 98 wt % or more, for example, about 99 wt % to about 100 wt %, in the composition in terms of solid content. Within this range scope, the composition can readily realize the effects of the present disclosure.

The composition may further include a silane coupling agent.

The silane coupling agent can improve adhesion of the adhesive film. The silane coupling agent may include a typical silane coupling agent known to those skilled in the art. For example, the silane coupling agent may include epoxy group-containing silane coupling agents, such as glycidoxypropyltrimethoxysilane and glycidoxypropylmethyldimethoxysilane, without being limited thereto.

The silane coupling agent may be present in an amount in a range of about 0.01 parts by weight to about 5 parts by weight relative to 100 parts by weight of the (meth)acrylic binder. Within this range, the composition can further increase peel strength of the adhesive film.

The composition may further include additives. The additives may include typical additives known to those skilled in the art. For example, the additives may include at least one of pigments, UV absorbents, and leveling agents without being limited thereto.

The adhesive composition may further include a solvent. The solvent can increase coatability of the adhesive composition to form an adhesive film having a thin thickness and a substantially uniform surface. The solvent may include typical solvents known to those skilled in the art. For example, the solvent may include at least one of methyl ethyl ketone, methyl isobutyl ketone, ethyl acetate, and the like, without being limited thereto. In one example embodiment, the adhesive composition may be present in a solid content in a range of about 20 wt % to about 30 wt %, for example 20 wt % to 25 wt %, in the adhesive film. Within this range, the adhesive composition can exhibit desired coatability.

The adhesive film may have a haze in a range of about 2% or less, for example about 0.1% to about 1%, and a total luminous transmittance in a range of about 90% or more, for example about 95% to about 99%, in the visible spectrum (for example, in the wavelength range of about 380 nm to about 780 nm). Within this range, the adhesive film has desired transparency to be included in an optical display apparatus.

According to one example embodiment, the optical member includes a polyimide-based optical device containing a polyimide ash in at least one surface thereof; and an adhesive film adhered to the one surface containing the polyimide ash therein.

The polyimide-based optical device may be or include an optical device having a polyimide layer formed on an outermost surface thereof. The polyimide layer may be formed of or include a composition including at least one of a polyimide polymer, a polyimide copolymer, a polyimide oligomer, and a polyimide monomer. A remaining portion of the polyimide-based optical device excluding the polyimide layer may be composed of or include a single layer or multiple layers. According to one example embodiment, the “polyimide-based optical device” may be or include a panel for optical displays, a protective film for optical displays, or the like, and may be or include, for example, an optical device in a foldable optical display.

The polyimide ash may be prepared by the method described above with reference to FIG. 1.

The adhesive film may include the adhesive film according to the example embodiments of the disclosure described above.

A typical optical device may be further stacked on one surface of the polyimide-based optical device to which the adhesive film is not adhered. Such an optical device can provide conductivity and/or optical functions, for example, light emission, polarization, optical compensation, and display quality improvement, to an optical display apparatus. For example, the optical device may include at least a window film, a window, a polarizing film, a polarizing plate, a color filter, a retardation film, an elliptical polarizing film, a reflective polarizing film, an antireflection film, a compensation film, a brightness enhancement film, an alignment film, a light diffusion film, a glass-shatterproof film, a surface protection film, an OLED device barrier layer, a plastic LCD substrate, a transparent electrode film including indium tin oxide (ITO), fluorinated tin oxide (FTO), aluminum-doped zinc oxide (AZO), carbon nanotubes (CNT), Ag nanowires, or graphene, and the like. Such optical devices can be readily manufactured by one having ordinary knowledge in the art.

A typical optical device, protective film, or adhesive film for performing a specific function may be further stacked on one surface of the adhesive film, to which the polyimide-based optical device is not attached. For example, the function may include a light shielding function. The light-shielding function may be performed by, e.g., a black light-shielding dye or a light-shielding pigment.

According to one example embodiment, the optical display apparatus includes the adhesive film or the optical member.

The optical display apparatus may include an organic light emitting device display, a liquid crystal display, and the like. The optical display apparatus may include a foldable optical display apparatus. However, the optical display apparatus may also include a non-foldable optical display apparatus.

Below, the present disclosure is described in more detail with reference to examples. However, it should be understood that these examples are provided for illustration only and should not be construed in any way as limiting the disclosure.

### Example 1: Manufacture of Adhesive Film

A (meth)acrylic binder (glass transition temperature: −65° C.) was prepared by polymerizing 100 parts by weight of a monomer mixture including 2-ethylhexyl acrylate (2-EHA), n-butyl acrylate (n-BA) and 4-hydroxybutyl acrylate (4-HBA).

A (meth)acrylic oligomer (glass transition temperature: 30° C.) was prepared by polymerizing 100 parts by weight of a monomer mixture including 4-hydroxybutyl acrylate and methyl methacrylate.

An adhesive composition having a solid content of 20 wt % was prepared by mixing 100 parts by weight of the (meth)acrylic binder, 1 part by weight of the (meth)acrylic oligomer, 0.1 part by weight of an isocyanate curing agent (toluene diisocyanate curing agent, Saiden Co., Ltd.), 0.05 part by weight of an antistatic agent (FC4400, tri-m-butylmethylammonium bis(trifluoromethanesulfonyl)imide, 3M), and methyl ethyl ketone as a solvent.

The prepared adhesive composition was deposited to a thickness of 15 m on a polyethylene terephthalate film as a first release film, and cured at 100° C. for 3 min, followed by stacking a polyethylene terephthalate film as a second release film thereon, thereby preparing an adhesive sheet having a stack structure of the first release film/adhesive film/second release film.

### Examples 2 to 4: Manufacture of Adhesive Film

The monomer mixture for the (meth)acrylic binder in Example 1 was changed. Adhesive sheets were prepared in the same manner as in Example 1, with a difference that the type and/or content of each component in Example 1 was changed as listed in Table 1.

### Comparative Examples 1 to 3: Manufacture of Adhesive Film

The monomer mixture for the (meth)acrylic binder in Example 1 was changed. Adhesive sheets were prepared in the same manner as in Example 1, with a difference that the type and/or content of each component in Example 1 was changed as listed in Table 1 below.

### Reference Example: Preparation of Polyimide Layer Containing Polyimide Ash on One Surface Thereof

A polyimide layer containing polyimide ash on one surface thereof was formed.

A polyimide varnish (DuPont) was deposited to a thickness of 30 m on an upper surface of an alkali-free glass plate (thickness: 1.1 mm) to form a polyimide varnish coating layer. The polyimide varnish coating layer was dried at 150° C. for 30 min and cured at 250° C. for 30 min to form a cured polyimide layer (thickness: 30 m) on the upper surface of the alkali-free glass plate. The lower surface of the alkali-free glass plate was irradiated with laser beams (coherent) at room temperature and was left at 25° C. for 1 hour, followed by removing the alkali-free glass plate from the cured polyimide layer, thereby preparing a polyimide layer containing a polyimide ash on a surface thereof, from which the alkali-free glass plate was removed.

An adhesive film was prepared by peeling off the PET (polyethylene terephthalate) film from the adhesive sheet prepared in each of Examples and Comparative Examples and was evaluated as to properties listed in Table 1 below. Evaluation results are shown in Table 1.

(1) Peel strength (unit: gf/inch): The adhesive sheet of each of Examples and Comparative Examples was cut into a size of 25 mm×25 mm (length×width) and the first release film was peeled off from the adhesive sheet. One surface of the adhesive film with the first release film removed therefrom was adhered to the polyimide ash-containing surface of the polyimide layer (having a size of 100 mm×25 mm (length×width)) and the second release film was peeled off of the adhesive sheet. Then, a PET film (length×width (100 mm×25 mm)) (subjected to corona treatment twice at 78 doses each time, Heat-resistant PET, Toray) was adhered to the other surface of the adhesive film and was pressed by a 2 kg hand roller, thereby preparing a specimen. The specimen has a shape in which the adhesive film is disposed between one end of the polyimide layer and one end of the PET film.

The prepared specimen was secured to a peel strength tester (TA.XT. Plus Texture Analyzer, Stable Micro System, Inc.). At 25° C., the adhesive film and PET film were pulled to 180° at a speed of 300 mm/min from the polyimide ash-containing surface to measure peel strength of a region in which peel strength remains constant while the adhesive film and PET film were peeled off of the polyimide ash-containing surface.

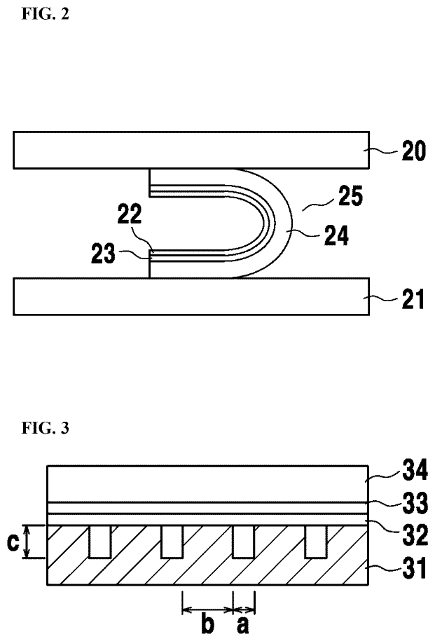

(2) Flexural properties: An adhesive film was prepared by separating both release films from the adhesive sheet prepared in each of Examples and Comparative Examples. As illustrated in FIG. 2, with the adhesive film 23 adhered to the polyimide ash-containing surface of the polyimide layer 22, a PET film 24 (subjected to corona treatment twice at 78 doses each time, Heat-resistant PET, Toray) was adhered to the adhesive film 23 and was pressed by a 2 kg hand roller, thereby preparing a rectangular specimen 25 (2.5 cm×10 cm, width×length).

A specimen for evaluation of flexural properties was prepared by bending the rectangular specimen 25 at a half point thereof in the transverse direction and securing the rectangular specimen 25 between a first fixture 20 and a second fixture 21, as shown in FIG. 2. The first fixture 20 and the second fixture 21 were secured to form a radius of curvature of 1.5 cm so as not to move. The specimen was maintained at 25° C. for 3 days. Then, the polyimide layer 22 was visually evaluated as to generate bubbles between the polyimide ash-containing surface and the adhesive film 23.

Generation of no bubbles was rated as “∘,” and generation of bubbles was rated as “x.”

(3) Step-filling properties: An adhesive film was prepared by separating both release films from the adhesive sheet prepared in each of Examples and Comparative Examples. With the adhesive film 32 adhered to the surface of the polyimide layer 32 provided with the polyimide ash, a PET film 34 (subjected to corona treatment twice at 78 doses each time, Heat-resistant PET, Toray) was adhered to the adhesive film 32 and was pressed by a 2 kg hand roller, thereby preparing a rectangular sample (5 cm×12 cm, width×length).

As shown in FIG. 3, a specimen was prepared by preparing a patterned portion 31 having a pattern on an upper surface thereof, and stacking the rectangular sample on the patterned portion 31 such that an upper surface of the pattern contacts the polyimide layer 32 of the sample. The pattern had a length “a” of 15 m, a length “b” of 0.8 cm, a height “c” of 1.4 cm, and a rectangular cross-section, and the patterned portion was formed of polyethylene terephthalate.

Generation of bubbles between the polyimide layer 32 and the adhesive film 33 was visually checked.

Generation of no bubbles therebetween was rated as “∘,” and generation of bubbles was rated as “x.”

(4) Antistatic performance (unit: Ω): Antistatic performance was measured by a probe method.

TABLE 1

| | | (Meth)acrylic | | | | | | | |
|---|---|---|---|---|---|---|---|---|---|
| | Tg (° C.) of | oligomer | | | | | | Step- | |
| | (meth)acrylic | Tg | | Curing | Antistatic | Peel | Flexural | filling | Antistatic |
| | binder | (° C.) | Content | agent | agent | strength | properties | properties | performance |
| Example 1 | −65 | 30 | 1 | 0.1 | 0.05 | 380 | ∘ | ∘ | 1.5 × 10¹¹ |
| Example 2 | −60 | 30 | 1 | 0.1 | 0.05 | 420 | ∘ | ∘ | 1.5 × 10¹¹ |
| Example 3 | −50 | 30 | 1 | 0.1 | 0.05 | 440 | ∘ | ∘ | 1.5 × 10¹¹ |
| Example 4 | −40 | 30 | 1 | 0.1 | 0.05 | 470 | ∘ | ∘ | 1.5 × 10¹¹ |
| Comparative | −35 | 30 | 1 | 0.1 | 0.05 | 480 | x | x | 1.5 × 10¹¹ |
| Example 1 | | | | | | | | | |
| Comparative | −60 | 30 | 1 | 1 | 0.05 | 150 | x | ∘ | 1.5 × 10¹¹ |
| Example 2 | | | | | | | | | |
| Comparative | −60 | 30 | 7 | 1 | 0.05 | 450 | x | x | 1.5 × 10¹¹ |
| Example 3 | | | | | | | | | |

As shown in Table 1, the adhesive films according to the example embodiments have a high peel strength of 300 gf/inch or more with respect to the polyimide ash-containing surface, and thus can be highly reliably adhered thereto. The adhesive films according to the example embodiments have desired flexural properties and antistatic performance. The adhesive films according to the example embodiments have desired step-filling properties by reducing or preventing the generation of bubbles even in the step-filling properties test under the severe conditions illustrated in FIG. 3. Therefore, the adhesive films according to the example embodiments are expected to have desired or improved step-filling properties even with respect to steps caused by the polyimide ash when adhered to the polyimide ash-containing surface of the polyimide-based optical device.

Conversely, the adhesive films of Comparative Examples failed to provide the positive effects of the adhesive films according to the example embodiments described above.

It should be understood that various modifications, changes, alterations, and equivalent embodiments can be made by those skilled in the art without departing from the spirit and scope of the disclosure.

What is claimed is:

1. An adhesive film for a polyimide-based optical device containing a polyimide ash, the adhesive film comprising:
a cured product of a composition comprising about 100 parts by weight of a (meth)acrylic binder having a glass transition temperature (Tg) in a range of about −70° C. to about −40° C.,
about 0.1 parts by weight to about 5 parts by weight of a (meth)acrylic oligomer,
about 0.01 parts by weight to about 0.5 parts by weight of a curing agent, and
an antistatic agent.

2. The adhesive film as claimed in claim 1, wherein the adhesive film has a peel strength in a range of about 300 gf/inch or more with respect to a polyimide ash-containing surface of the polyimide-based optical device.

3. The adhesive film as claimed in claim 1, wherein the cured product comprises a thermally cured product.

4. The adhesive film as claimed in claim 1, wherein the (meth)acrylic binder comprises a (meth)acrylic copolymer of a monomer mixture comprising a (meth)acrylic monomer having a homopolymer glass transition temperature in a range of about −50° C. or less.

5. The adhesive film as claimed in claim 4, wherein the (meth)acrylic monomer having the homopolymer glass transition temperature in a range of about −50° C. or less comprises a straight or branched C₁ to C₁₀ alkyl group-containing (meth)acrylic acid ester.

6. The adhesive film as claimed in claim 4, wherein the (meth)acrylic monomer having the homopolymer glass transition temperature in a range of about −50° C. or less is present in an amount in a range of about 90 wt % or more in the monomer mixture.

7. The adhesive film as claimed in claim 1, wherein the (meth)acrylic oligomer has a glass transition temperature in a range of about 10° C. to about 40° C.

8. The adhesive film as claimed in claim 1, wherein the (meth)acrylic oligomer comprises an oligomer of a monomer mixture comprising a hydroxyl group-containing (meth)acrylic monomer.

9. The adhesive film as claimed in claim 1, wherein the curing agent comprises an isocyanate curing agent.

10. The adhesive film as claimed in claim 1, wherein the (meth)acrylic binder, the (meth)acrylic oligomer, the curing agent and the antistatic agent are present in a total amount in a range of about 98 wt % or more in the composition in terms of solid content.

11. An optical member comprising:
a polyimide-based optical device containing a polyimide ash in at least one surface thereof; and
an adhesive film adhered to the polyimide ash-containing surface of the polyimide-based optical device, the adhesive film being the adhesive film of claim 1.

12. The optical member as claimed in claim 11, wherein the polyimide-based optical device comprises a panel for optical displays.

13. The optical member as claimed in claim 11, wherein an optical device is further stacked on a surface of the polyimide-based optical device to which the adhesive film is not adhered.

14. The optical member as claimed in claim 13, wherein the optical device comprises at least one of a window film, a window, a polarizing film, a polarizing plate, a color filter, a retardation film, an elliptical polarizing film, a reflective polarizing film, an antireflection film, a compensation film, a brightness enhancement film, an alignment film, a light diffusion film, a glass-shatterproof film, a surface protection film, an OLED device barrier layer, a plastic LCD substrate, and a transparent electrode film.

15. The optical member as claimed in claim 11, wherein at least one of a functional optical device, a protective film, and an adhesive film is further stacked on one surface of the adhesive film to which the polyimide-based optical device is not attached.

16. The optical member as claimed in claim 15, wherein at least one of the optical device, the protective film, and the adhesive film has a light shielding function.

17. An optical display apparatus comprising the adhesive film of claim 1.
